(19) United States
(12) Patent Application Publication
(10) Pub. No.: US 2015/0289721 A1
(43) Pub. Date: Oct. 15, 2015

(54) Handheld battery operated mixing and dispensing appartaus

(71) Applicant: Tabitha Lynn Tucker, Vineland, NJ (US)

(72) Inventor: Tabitha Lynn Tucker, Vineland, NJ (US)

(21) Appl. No.: 14/250,864

(22) Filed: Apr. 11, 2014

(51) Int. Cl. A47J 43/044; B01F 7/00; B01F 15/02; B01F 13/00; B01F 15/00

(52) U.S. Cl. CPC A47J 43/044; B01F 13/003; B01F 15/00519; B01F 15/00538; B01F 15/00844; B01F 15/0276; B01F 7/0025; B01F 15/0292; B01F 2215/0014; A47J 2043/04409

(57) ABSTRACT

A handheld battery operated mixing and dispensing apparatus with a controllable release valve that includes: A mixing chamber and detachable funnel that works in conjunction with a release valve to control the release and flow of mixed food ingredients. The funnel itself has threading along the spout for decorating tips. Further including a base/stand to support and hold the apparatus in place while mixing ingredients or as a storage container while the apparatus is not in use. The chamber is self contained, comes with measuring marks on the side of the chamber and comes with interchangeable lids for a variety of functions. Included in these lids is a lid that has an affixed mixer blade, which is form fitted to the chamber and designed to scrap the top and sides of the chamber while mixing the ingredients at the same time. The mixer blade is powered by a mini DC motor and is battery operated eliminating an electrical cord interfering or being in the way while mixing, beating or dispensing ingredients. The apparatus further provides a method of mixing, beating or blending food ingredients in a sealed container and dispensing a controlled amount of mixture. This eliminates any subsequent mess or residue normally left from mixing ingredients and reduces the amount of measuring cups and bowls needed.

This invention relates to a device and to a method. More specifically, this invention is directed to a self contained device for mixing, beating, and dispensing ingredients in a food recipe with a controlled release of such ingredients. In one of preferred embodiments of the inventions a mixer blade is battery powered by a mini DC motor and affixed to a lid. The design of the blade allows the sidewalls of the chamber to be continuously scraped with the inner parts of the blade mix the ingredients. While the device is handheld when it is placed in it's base/stand this allows the mixer blade to continue running without the need to manually mix ingredients or hold the apparatus to ensure the ingredients are being mixed properly. This also eliminates the need for an electrical cord that previous electric mixer have. This invention includes a delivery method of the contents for a preferred amount to a target place. This invention also includes a method to accurately measure, mix ingredients and dispense contents in a self contained chamber. And provides multi functions with the use of one appliance.

### DESCRIPTION OF PRIOR ART

The use of containers and method of mixing ingredients in a food recipe is a common practice in the home and food industry. Typically devices that are used are handheld electric mixers or manually operated mixing devices. Examples of such prior devices include that described in U.S. Pat. No. 8,251,567 issued on Aug. 28, 2012. This patent refers to an electric mixer with an attached bowl. Even though this does provide a bowl for the ingredients to be mixed in it does not provide a means to dispense such ingredients. Nor does it have a means to completely contain the ingredients in the bowl itself. In U.S. Pat. No. 1,743,271 issued on Jan 14, 1930 the patent refers to a handheld electric mixer. This does not provide a means to mix the ingredients without having to hold the mixer and move it around a container. This patent also does not provide another means to power the mixer other than an electrical cord. The problem with previous inventions includes: having to use multiple devices or containers, residue from the ingredients that come out of a container while using a previously invented device covering the work surface, an electrical cord from an electrical mixer that gets in the way, having to manually mix or hold a mixing device for a determined amount of minutes according to a recipe, inability to control the release of such ingredients and inability to properly store leftover ingredients in an air tight container that was used to mix the ingredients.

### OBJECTS OF INVENTION

It is the object of this invention to remedy the above as well as related deficiencies in the prior art.

More specifically, it is the principle object of this invention to provide a device that can mix, beat and dispense ingredients in a food recipe without the use of multiple containers and without the associated mess that is left after wards.

It is another object of this invention to provide a device that allows controlled release and flow of ingredients into a specific place.

It is still another object of this invention to provide a means to measure ingredients in the device itself. Eliminating the need for additional measuring devices.

It is yet another object of the invention to allow the user to mix and beat ingredients without the need of a power cord.

It is another object of the invention to allow the user to allow the mixer blade to run without having to manually mix, scrape the sides of the container or to hold the device while it is mixing.

It is an additional object of this invention to allow a variety of attachments and uses. Allowing it to be a multi use kitchen device.

It is another object of this invention to provide a method for mixing, beating and dispensing food ingredients.

### SUMMARY OF THE INVENTION

The above and related objects are achieved by providing a device for the mixing, beating and dispensing ingredients with a release hatch and trigger which allows control of the flow of contents in the mixing chamber. In one of the preferred embodiments of the invention, the device is battery powered and the mixer blade is operated with a round rocker switch which powers the mini DC motor. The mixer blade is designed in such a way that it allows the form fitted blade to scrap the sidewalls and bottom of the chamber while the ingredients are mixed.

### BRIEF DESCRIPTION OF DRAWINGS

The drawings, which are provided and described herein, are intended to be illustrative of a number of the preferred embodiments of the invention and precise specifications of how each part of the apparatus and attachments are assembled. Reference numbers have been assigned to every part of this apparatus and when an element of an illustration is common to more than one drawing, it is assigned the same reference number.

FIG. 1 is a detailed illustration of the mixing chamber showing a side (FIG. 1A), back (FIG. 1D), bottom (FIG. 1B) and top (FIG. 1C) view. Included in this illustration is the marks of specific gradations of measurement, the aperture at the bottom of the chamber, the threaded aperture at the top of the chamber and the spring pin and rod attached to the chamber.

FIG. 2 is a detailed view of the mixing chamber after it is securely fastened in the handle and support base (FIG. 2A). It provides an illustration of the inner workings of the handle which house the release hatch and trigger (FIG. 2C). It also shows a front (FIG. 2B) and bottom view of the handle and support base (FIG. 2D).

FIG. 3 is a perspective view of the device with the attached funnel (FIG. 3A), attached storage lid (FIG. 3B) and the decorating tips that can be attached (FIG. 3C-FIG. 3J).

FIG. 4 is a detailed view of the preferred embodiment of the apparatus with the mixer blade lid (FIG. 4A and FIG. 4C). It also contains an inside top (FIG. 4B) and bottom view (FIG. 4D) of the housing for the motor, batteries and round rocker switch.

FIG. 5 is a perspective view of the apparatus with the push lid attachment (FIG. 5A and FIG. 5B) and also a perspective view of the electric mixer lid attachment (FIG. 5C and FIG. 5D).

FIG. 6 is a perspective view of the base/stand showing the apertures and plastic extensions used for storing all parts of the apparatus (FIG. 6A). It also contains a perspective view of all the components of this device when it is assembled (FIG. 6B).

### DETAILED DESCRIPTION OF THE INVENTION

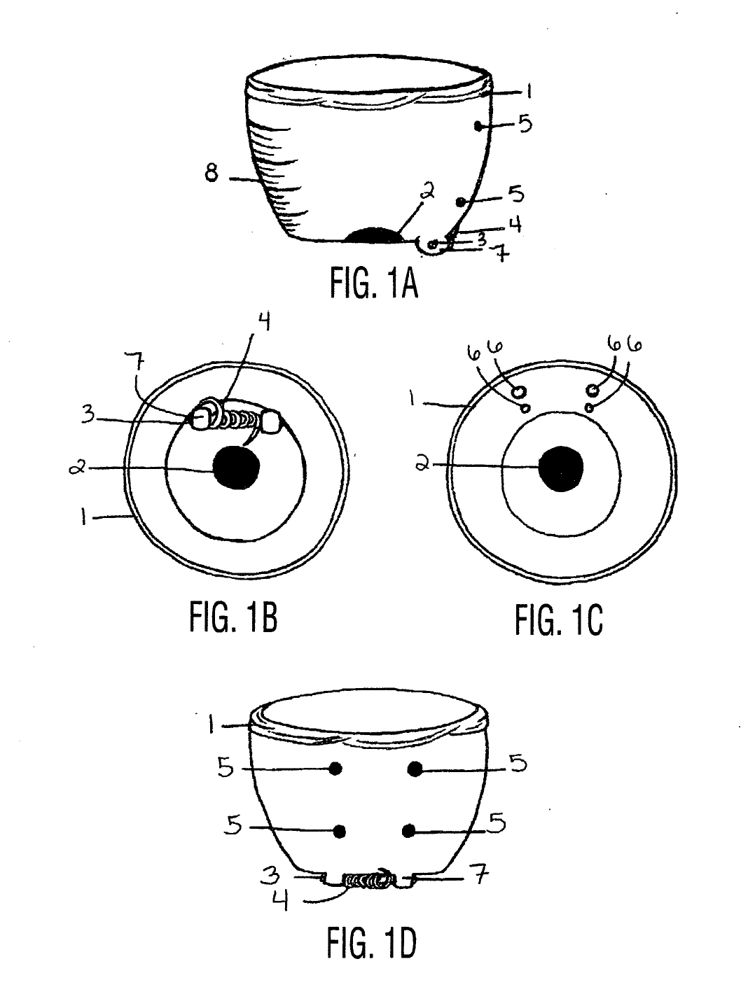

FIG. 1 is a detailed view of. the main mixing chamber. It shows a threaded opening (1) at the top of the lid used to attach interchangeable lids for a variety of functions. The sidewall of the chamber itself has specific marking along the side for gradations of measurement (8) allowing the measuring and mixing to all be done in the same apparatus eliminating the need for additional measuring cups when combining ingredients for a food recipe. On the bottom of the chamber is an aperture (2) where the ingredients can be released from. The outside side wall along the back of the chamber contains four holes (5) and the inside of the side wall along the back of the chamber contains for screw bases (6) providing a means to attach the handle, support base and hatch. The mixing chamber has two plastic eyelet extensions (7) on both sides in the back of the chamber allowing a rod and screws (3) to hold the spring pin (4) in place while it keeps the hatch shut.

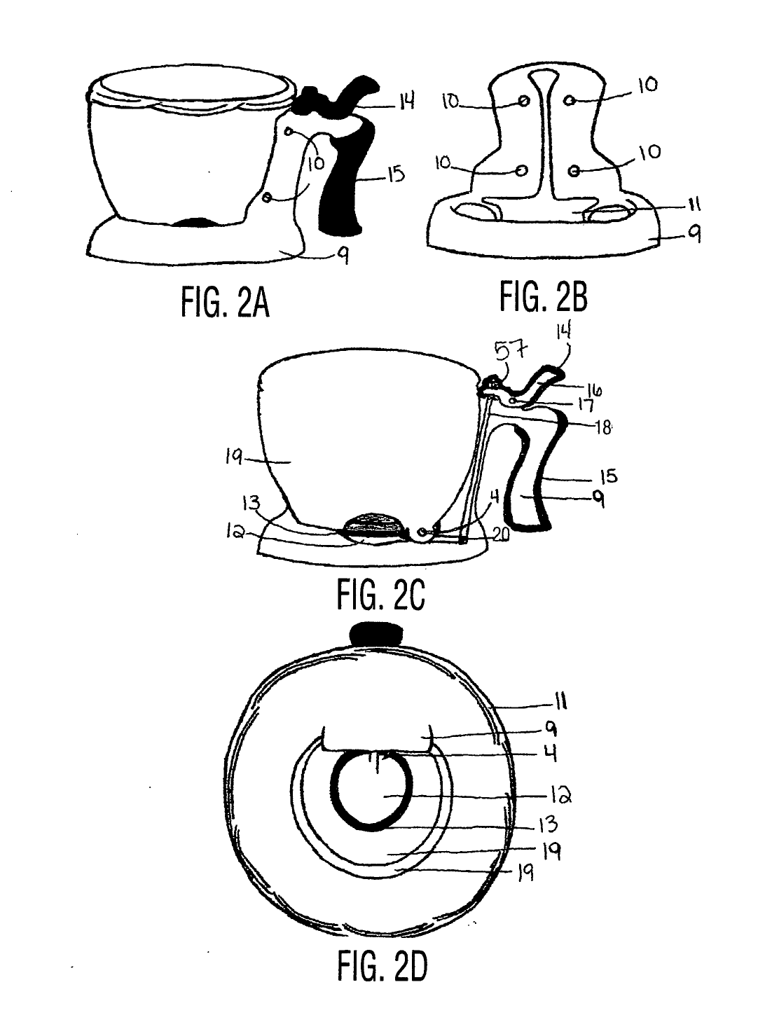

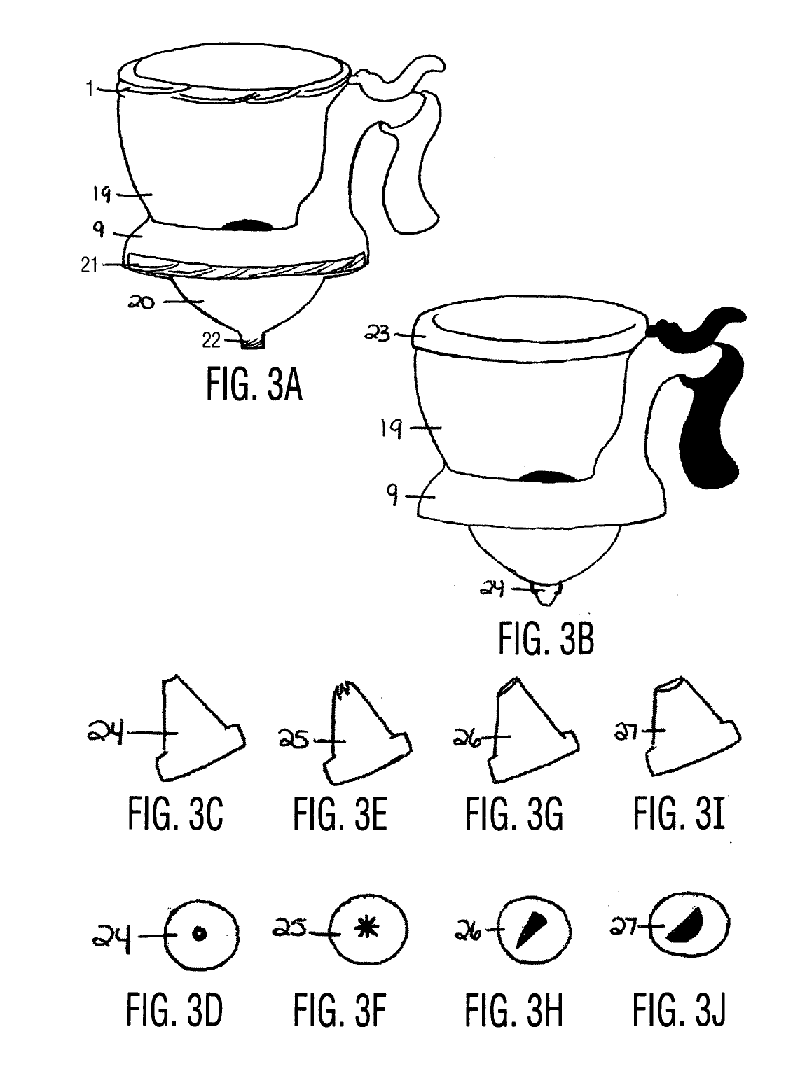

FIG. 2 is a detailed view of the handle and support base (9) after it is attached to the mixing chamber (19) by it's four holes (10) for screws. It shows how the rod (18), trigger (16), bolt (57), trigger hinge (17), rod hinge (20) and hatch (12) work in conjunction with one another. It also shows how the release hatch and working parts will fit in a cavity (11) in the handle and support base. Whereby none of the working parts will be exposed. The trigger will be covered by rubber (14) providing a casing for the trigger and preventing exposure of the working parts. The handle also features a rubber grip (15) designed for comfort. While the latch features a silicone rubber rim (13) designed to help ensure the hatch is airtight. Furthermore, the support base of the handle has threading (11) on the inside of the bottom opening to attach a funnel. FIG. 3 is a detailed view of the mixing chamber (19), handle (9) and funnel (20) after they are attached. It shows the threading that is needed on the extended rim (21) of the funnel so that it can be attached to the base (9). Also it shows the threaded spout (22) of the funnel where decorating tips (24-27) can be attached. Lastly, there is a side view of the device with the storage lid (23) attached (FIG. 3B).

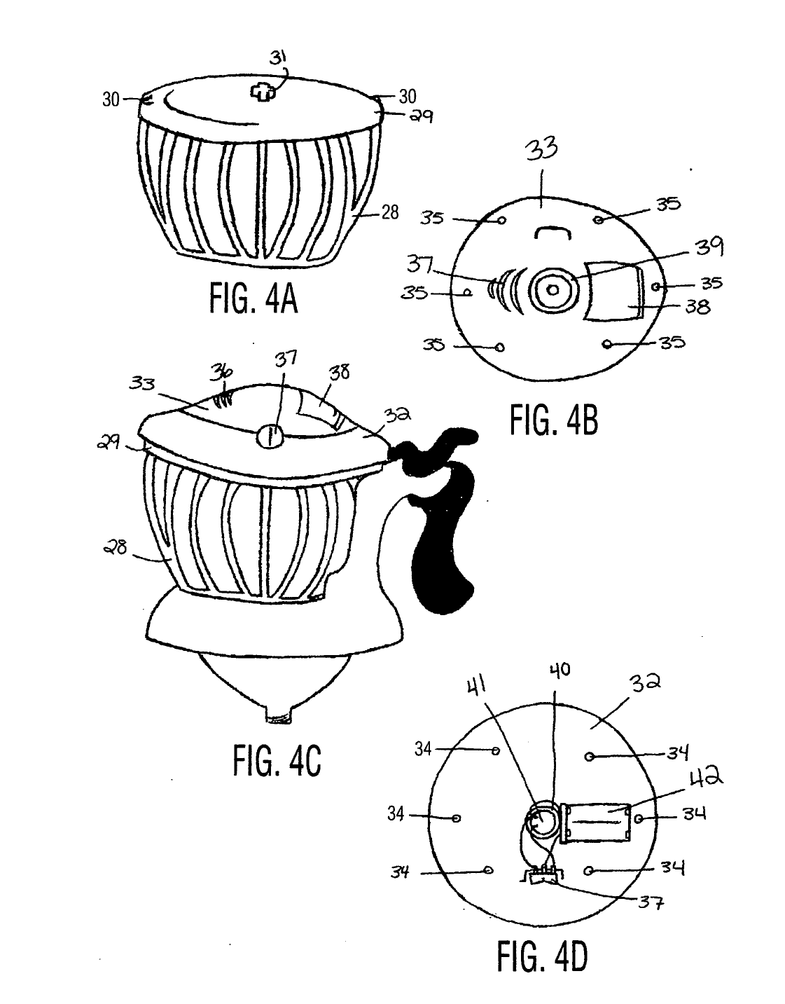

FIG. 4 is a detailed view of the preferred embodiment of the apparatus (FIG. 4C). It contains a detailed illustration of the mixer blade lid (29 and FIG. 4A). It shows the design of the mixer blade (28) and how it is form fitted to not only scrape the sides of the bowl but have the ability to mix and beat ingredients simultaneously. Said mixer blade attaches to a locking gear (31) through a hole in the lid. The lid itself is powered by a mini DC motor (41) The housing unit for the motor attaches to the mixer lid by locking into place with the plastic extensions (30) and the lid itself. The housing unit of the motor consists of two parts. The lower portion of the housing unit (32 and FIG. 4D) contains a casing for the motor (40) to hold it in place, a cavity for the round rocker switch (37), a cavity for the batteries (42) and six holes (34) to allow you to screw the lower cavity into the upper cavity. The upper housing unit for the motor (33 and FIG. 4B) simply consists of a casing for the top of the motor (39), three apertures (37) to allow ventilation to the motor, a door (38) to allow access to the batteries once put together and six holes (37) to screw the upper and lower housing units together. This figure also shows the perspective view of preferred embodiment put together (FIG. 4C).

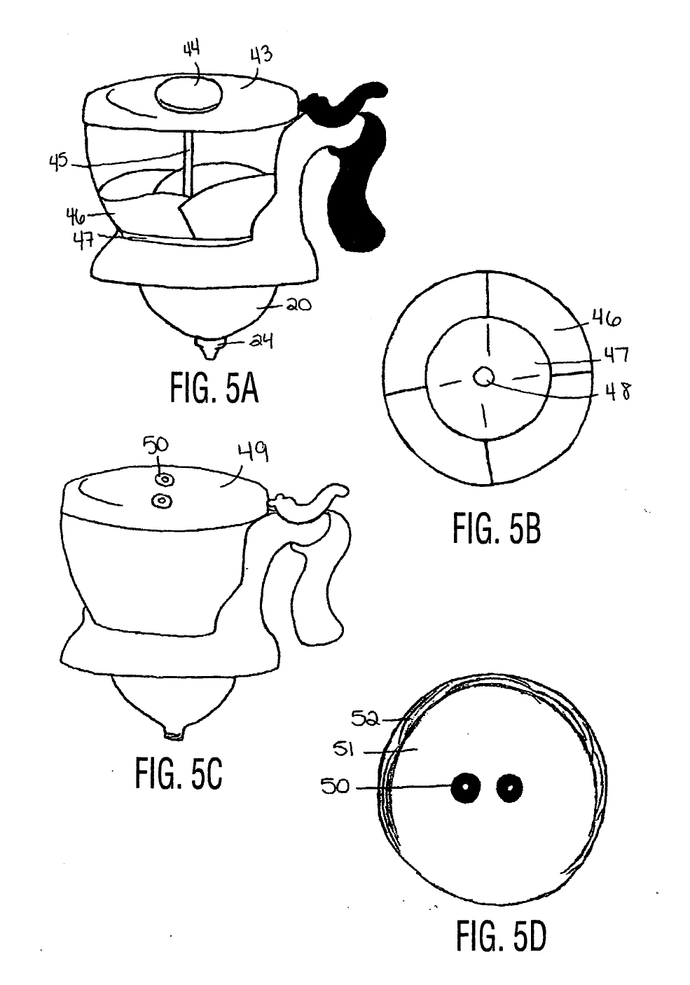

FIG. 5 is a detailed drawing of the push lid (43) when it is attached to the apparatus(FIG. 5A). On one end of the lid you have a circular handle (44) which is affixed to a rod (45) going through the lid and mounted on the opposite end of the rod is the first larger push(46) having the largest diameter of the mixing container and four apertures allowing the push to fold up into itself when being pushed down. Underneath of that is a stationary push (47) made of a harder plastic and having the smallest diameter of the container. It is then held into place with a plastic screw (48). This attachment is for pushing out thicker mixtures or frosting. Also included in FIG. 5 is a perspective view of the electric mixer blade attachment lid (49 and FIG. 5C). This is meant to be used in conjunction with an already existing electric mixer of choice. The two rubber silicone cones (50) are held in place by adhesive and a smaller inside lid (51) affixed to the lid (49) underneath of the threaded inside rim (52). The use for this lid is to slide your mixer blades through the inside and attached to already existing mixer. The cone shape is designed to prevent any residue from coming out of the holes and also to have the ability of moving the mixer blades around the chamber with ease.

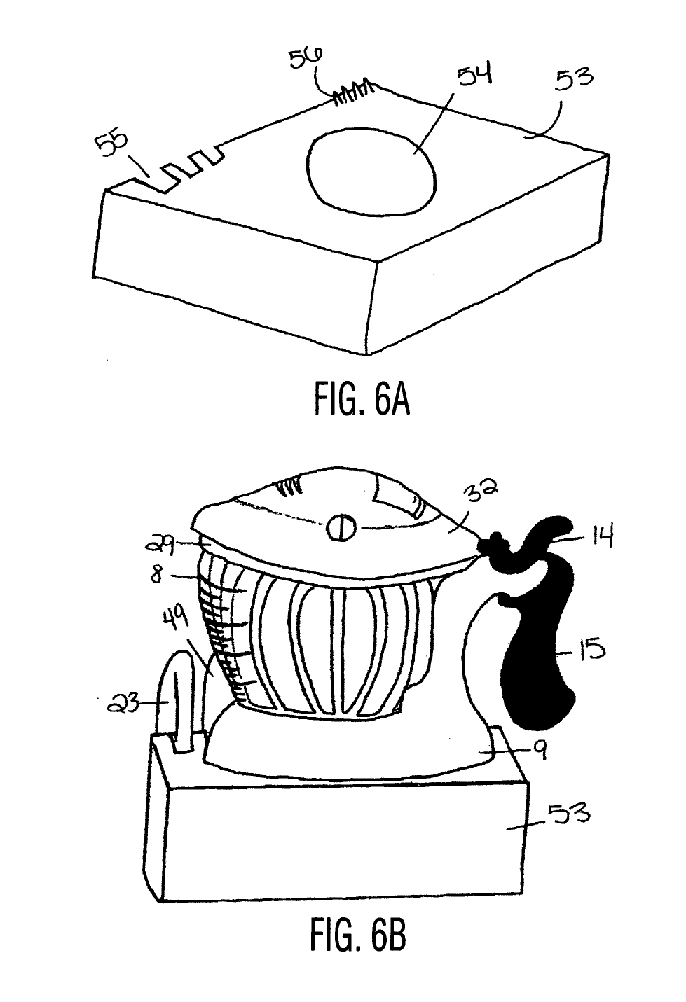

FIG. 6 shows the perspective view of the base/stand (53) which consists of an opening in the middle (54), three apertures (55) in the back of the stand used to store the interchangeable lids and four plastic extensions (56) on the opposite side used to store the decorating tips (FIG. 6A). Also contained in this figure is a perspective view of the apparatus and all of the attachments housed in the base/stand (FIG. 6B).

1. Handheld battery operated mixing and dispensing apparatus, the apparatus comprising: a mixing chamber and attached handle and support base containing a trigger and controllable release hatch. The mixing chamber consists of side walls, a threaded aperture at the top to attach interchangeable lids, a centered aperture at the bottom of the chamber to release its contents and a typical set of marks to indicate specific gradations of measurement.

2. The apparatus of claim 1, the apparatus further comprising an attachment area located at the top of the mixing chamber whereby the interchangeable mixer lid provides a means to mix the ingredients inside the chamber using a DC motor.

3. The apparatus of claim 1, the apparatus further comprising a threaded attachment area at the bottom of the support base whereby a detachable funnel can be attached to more efficiently control the released flow of ingredients.

4. The apparatus of claim 2, the interchangeable mixer lid further comprising of an affixed mixer blade form fitted to the mixer chamber and designed to scrape the sides and bottom of the chamber while mixing the ingredients.

5. The apparatus of claim 2, the interchangeable mixer lid further comprising of a housing unit for the 6 volt mini DC motor attached to a gear, cavity for the batteries, apertures for ventilation and a round rocker switch to power the device on and off.

6. The apparatus of claim 2, the housing unit is removable from the mixer blade lid allowing the lid to be cleaned properly.

7. The apparatus of claim 3, the funnel further comprising of a threaded spout whereby decorating tips can be attached.

8. The apparatus of claim 1, wherein the size and shape of the mixing chamber is hemispherical with a flat bottom.

9. The apparatus of claim 1, further comprising of a base/stand whereby the mixing chamber can be placed in for storage and while the ingredients are being measured or mixed.

10. The apparatus of claim 9, the base/stand having an aperture in off put from the center allowing the mixing chamber with attached funnel to be stored in and have access to additional room in back of the apparatus' base/stand for storage of interchangeable lids and decorating tips.

11. The apparatus of claim 1, the apparatus further comprising a threaded attachment area at the top of the mixing chamber whereby the interchangeable storage lid can be attached.

12. The apparatus of claim 1, the apparatus further comprising a threaded attachment area at the top of the mixing chamber whereby the interchangeable push lid can be attached.

13. The apparatus of claim 12, the interchangeable push lid further comprising of a circular handle affixed to a rod. There are two circular pushes mount on the opposite side of the rod. One being the diameter of the top of the mixing chamber containing four apertures and the other being a stationary circular push the diameter of the bottom of the container. The apertures allow the first push to fold up and scrape down the sides of the chamber while being pushed into a smaller diameter.

14. The apparatus of claim 1, the apparatus comprising a threaded attachment area at the top of the mixing chamber whereby the interchangeable electric mixer lid can be attached.

15. The apparatus of claim 14, the interchangeable electric mixer lid attachment consists of two punchouts affixed with silicone rubber cones whereby to slide your electric mixer blades through and attach to your electric mixer.

16. The apparatus of claim 1, the apparatus having and consisting of detachable parts to better clean attachments and chamber itself.
